(19) United States
(12) Patent Application Publication
(10) Pub. No.: US 2005/0101309 A1
(43) Pub. Date: May 12, 2005

(54) Method and apparatus for selective configuration based upon expansion card presence

(76) Inventor: Martin Croome, Brie et Angonnes (FR)

Correspondence Address: WALSTEIN BENNETT SMITH III, P. O. BOX 1668, GEORGETOWN, TX, 78628, US

(21) Appl. No.: 10/445,975

(22) Filed: May 27, 2003

Related U.S. Application Data
(60) Provisional application No. 60/383,997, filed on May 29, 2002.

(51) Int. Cl. H04M 11/00; H04M 1/66

(52) U.S. Cl. 455/418; 455/405; 455/410

(57) ABSTRACT

The present invention enables automatic customization, optimization, and adaptation of a wireless device when an accessory card is inserted. This adaptive provisioning is based on several factors, including the identification of the user of the wireless device, the specific wireless device and the specific accessory card, the service provider associated with the customization-related application or application suites (the “services”), the facility providing the downloaded service image to the wireless device, and selected configuration information. This allows a single wireless device, in conjunction with an assortment of accessory cards, to be specialized for efficient performance of a multitude of role or job-dependent functions, including application specific user interfaces, capabilities, privileges, and usage modes, in a modular flexible building-block fashion. More specifically, the user inserts the accessory card into the wireless device and with no further user intervention the enabled service is ready for the user. This is initiated via automatic download of a service image when the accessory card is inserted into the wireless device, followed, as soon as possible after or during the download, by automatic presentation of the service, including associated user interfaces, to the user. When the user completes the use of the service the user then removes the accessory card from the wireless device. Removing the accessory card automatically ceases execution of the service with no further user intervention. Caching mechanisms are used to reduce the time between accessory card insertion and availability of the enabled service to the user.

### BACKGROUND

Existing wireless systems include various wireless devices and associated accessory cards, with services and applications enabled by the combination of a wireless device and one or more accessory cards, where these services and applications are provided by service providers. In addition, these devices, cards, services, and providers cater to a multitude of users with differing abilities and needs. Finally, the complexity of the devices and related applications continues to increase, burdening the user with the overhead of managing portions of this complexity.

For example, when a user purchases a new accessory card for a GSM phone, the services and applications enabled by the accessory card must be identified, downloaded, and activated manually by the user. Similarly, when the user is finished using the service or application and is ready to remove the card, the user must first manually close down and stop the service or application. In addition, the user must configure the services and applications upon the first or subsequent activations of the services and applications while the accessory card is connected to the wireless device. Navigation of the services or applications provided is more difficult than the original wireless device alone. What is needed is an approach to ease the burden on the user of an accessory card for a wireless device, including service or application download, configuration, and termination.

### Nomenclature

In the wireless device industry certain common terms find repeated application at different levels of the design hierarchy and otherwise may be used with varying scope. As a result, it is possible that terms used in this application have multiple context dependent meanings. Particular attention is required with regard to the terms wireless device, wireless connection, wireless communication infrastructure, accessory card, service, wireless service server facility, host service server facility, and server communication infrastructure. Those of ordinary skill in the art will always be able to readily ascertain the correct meaning from careful study of the text, including the following terminology clarifications, and accompanying drawings.

The term wireless device refers to any device capable of communication with another wireless device or wireless service server facility. One example of a wireless device is a GSM phone. Wireless device communication to another wireless device or wireless service server facility occurs over a wireless connection. The term wireless communication infrastructure is used to refer to the wireless connection mechanism between the wireless devices. It may be as simple as one wireless device directly communicating with another wireless device using a direct radio connection, e.g. the Bluetooth System standard (described in “Specification of the Bluetooth System, Volumes 1 and 2, Version 1.1, Feb. 22, 2001”, from the Bluetooth SIG), or as complex as the GSM cellular phone network, including GPRS data communication mechanisms, capable of connecting wireless devices over short or long distances.

The term accessory card is used to mean any object that can be physically attached to or inserted into a wireless device, where the accessory card is used to enable additional functionality or services to a user of the wireless device. Such an accessory card is frequently (but is not limited to) a compact flash plug-in card.

The term service is used to describe the collection of software providing one or more functions to a user in conjunction with an accessory card inserted into a wireless device. This may be any combination of low-level device drivers, middleware application interfaces, high-level applications, and associated user interfaces.

### BRIEF DESCRIPTION OF DRAWINGS

FIG. 1 illustrates a wireless device and an accessory card, in accordance with the present invention.

FIG. 2 illustrates a service server facility in accordance with the present invention.

FIGS. 3A-E illustrate a wireless system showing insertion of an accessory card into a wireless device, download of a service image to the wireless device and inserted accessory card, automatic presentation of the service to the user, removal of the accessory card, and the subsequent termination of the downloaded service, in accordance with the present invention.

FIG. 4 illustrates a wireless system, showing a service image download, including details of the wireless and server communication infrastructures, in accordance with the present invention.

FIG. 5 illustrates a wireless system, showing caching of service image information between the source and the destination, in accordance with the present invention.

FIG. 6A illustrates a wireless device with an assortment of accessory cards, users, service server facilities, and associated service providers, showing customization of the provided service and associated user interface, in accordance with the present invention.

FIG. 6B illustrates a wireless device with an inserted accessory card and completed download of a customized service and associated user interface, in accordance with the present invention.

### SUMMARY

The present invention enables automatic customization, optimization, and adaptation of a wireless device when an accessory card is inserted. This adaptive provisioning is based on several factors, including the identification of the user of the wireless device, the specific wireless device and the specific accessory card, the service provider associated with the customization-related application or application suites (the “services” being provided), the facility providing the downloaded “service image” to the wireless device, and selected configuration information. This allows a single wireless device, in conjunction with an assortment of accessory cards, to be specialized for efficient performance of a multitude of role or job-dependent functions, including application specific user interfaces, capabilities, privileges, and usage modes, in a modular flexible building-block fashion.

More specifically, the user inserts the accessory card into the wireless device and with no further user intervention the enabled service is ready for the user. This is initiated via automatic download of a service image when the accessory card is inserted into the wireless device, followed, as soon as possible after or during the download, by automatic presentation of the service, including associated user interfaces, to the user. When the user completes the use of the service the user then removes the accessory card from the wireless device. Removing the accessory card automatically ceases execution of the service with no further user intervention. Selective customization of the service and associated user interface, based on the specific wireless device, accessory card, user, service server facility, and associated service provider is also provided when the service image is downloaded.

Sample Illustrative Methods and Apparatus

This summary section concludes with a collection of paragraphs that tersely summarize illustrative methods and apparatus in accordance with the invention. Each of the paragraphs highlights various combinations of features using an informal pseudo-claim format. These compressed descriptions are not meant to be mutually exclusive, exhaustive, or restrictive and the invention is not limited to these highlighted combinations. As is discussed in more detail in the Conclusion section, the invention encompasses all possible modifications and variations within the scope of the issued claims, which are appended to the very end of the patent.

A wireless device apparatus, comprising: a processor; a wireless access mechanism coupled to said processor; an accessory card interface coupled to said processor; and firmware executed under the control of said processor; wherein said firmware includes functions enabling: interrogation of identification information from a coupled accessory card via said accessory card interface; transmission of said identification information in the form of a service image download request via said wireless access mechanism; and reception of a downloaded service image responsive to said service image download request via said wireless access mechanism. The foregoing wireless device apparatus, wherein said firmware further includes functions enabling: storage of said downloaded service image as a temporary service image copy in the wireless device and said coupled accessory card. The foregoing wireless device apparatus, wherein said firmware further includes functions enabling: execution of said temporary service image copy, optionally using resources in said coupled accessory card via said accessory card interface, resulting in presentation for user interaction of a service embodied in said downloaded service image. The foregoing wireless device apparatus, wherein said firmware further includes functions enabling: cessation of execution of said temporary service image copy upon uncoupling of said coupled accessory card as indicated by said accessory card interface. The foregoing wireless device apparatus, wherein the wireless device further includes: a device service image cache coupled to said processor. The foregoing wireless device apparatus, wherein said firmware further includes functions enabling: storage of a cached copy of said downloaded service image in said device service image cache; maintenance of the coherence of said device service image cache via cache management protocols operative on said wireless access mechanism; and execution of said cached copy, optionally using resources in said coupled accessory card via said accessory card interface, resulting in presentation for user interaction of said service embodied in said cached copy. The foregoing wireless device apparatus, wherein said firmware further includes functions enabling: storage of a cached copy of said downloaded service image in a card service image cache, included in said coupled accessory card; maintenance of the coherence of said card service image cache via cache management protocols operative on said wireless access mechanism; and execution of said cached copy, optionally using resources in said coupled accessory card via said accessory card interface, resulting in presentation for user interaction of said service embodied in said cached copy. The foregoing wireless device apparatus, wherein said service download request further includes: login information identifying the user of the wireless device.

An accessory card apparatus, comprising: a control unit, an identification information providing block coupled to said control unit; and a device interface coupled to said control unit; wherein said control unit includes functions enabling: transmission of identification information from said identification information providing block in response to a request from an externally coupled wireless device via said device interface. The foregoing accessory card apparatus, wherein said control unit further includes functions enabling: use of any portion of the accessory card resources by said externally coupled wireless device via said device interface. The foregoing accessory card apparatus, further comprising: a card service image cache coupled to said control unit; wherein said control unit further includes functions enabling: maintenance of cache coherence of said card service image cache in response to commands and data from said wireless device coupled to said device interface; and cache access of said card service image cache in response to commands from said externally coupled wireless device via said device interface.

A service server facility apparatus, comprising: a general purpose computer system; a persistent storage mechanism coupled to said general purpose computer system, wherein a plurality of service images are stored; a communication mechanism coupled to said general purpose computer system; and software executed by said general purpose computer system including functions enabling: reception and interpretation of a service download request from said communication mechanism; selection and access of a single member of said plurality of service images in response to said service download request; and transmission of said selected and accessed single member on said communication mechanism. The foregoing service server facility apparatus, wherein said software further includes functions enabling: maintenance of the coherence of cached copies of said plurality of service images, via cache management protocols operative on said communication mechanism. The foregoing service server facility apparatus, wherein said software further includes functions enabling: production of a modified version of said accessed single member to effect service customization based on interpretation of accessory card and wireless device identification information received as part of said service download request, and transmission of said modified version on said communication mechanism. The foregoing service server facility apparatus, wherein said software further includes functions enabling: maintenance of the coherence of cached copies of said modified version, via cache management protocols operative on said communication mechanism. The foregoing service server facility apparatus, wherein said communication mechanism is a wireless access mechanism or a server communication mechanism.

A method of selective configuration, the method comprising: coupling an accessory module to a wireless device; the wireless device obtaining identification information from the accessory module; the wireless device transmitting a service download request to a service server facility via a wireless access mechanism, the service download request including the identification information and the service server facility having access to a plurality of service images; the service server facility responding to the service download request by selecting a first service image from the plurality of service images, the selecting being at least partially based on the identification information in the service download request; transmitting the first service image to the wireless device via said wireless access mechanism; and the wireless device and the accessory module in combination executing the first service image to provide a corresponding first service to a user of the wireless device and the accessory module. The foregoing method of selective configuration, further wherein the wireless device and the accessory module stop executing the first service image upon uncoupling of the accessory module from the wireless device. The foregoing method of selective configuration, the method further including caching at least a first portion of the first service image in a local service image cache, the local service image cache being local to the user. The foregoing method of selective configuration, wherein the local service image cache includes either or both a card service image cache included in the accessory module and a device service image cache included in the wireless device. The foregoing method of selective configuration, the method further comprising: uncoupling and later recoupling the accessory module and the wireless device; transmitting a modified service download request to the service server facility via the wireless access mechanism, wherein the modified service download request indicates the extent of the caching in the local service image cache; the service server facility responding to the modified service download request by selectively transmitting any non-locally-cached portions of the first service image to the wireless device via said wireless access mechanism; and the wireless device and the accessory card in combination executing the first service image to provide the first service to the user, wherein subsequent to the caching the first service image includes the cached portions and the portions that are non-locally-cached.

A method of selective configuration, the method comprising: coupling an accessory module to a wireless device; the wireless device obtaining identification information from the accessory module; the wireless device transmitting a service download request to a service server facility via a wireless access mechanism, the service download request including: login information identifying a user of the wireless device, information identifying the wireless device, and information identifying the accessory module; the service server facility responding to the service download request by dynamically constructing a customized service image based on at least some of the information provided in the service request; transmitting the customized service image to the wireless device via said wireless access mechanism; and the wireless device and the accessory module in combination executing the customized service image to provide a corresponding customized service to the user of the wireless device and the accessory module. The foregoing method of selective configuration of, further wherein the wireless device and the accessory module stop executing the customized service image upon uncoupling of the accessory module from the wireless device. The foregoing method of selective configuration, the method further including caching at least a first portion of the customized service image in a local service image cache, the local service image cache being local to the user. The foregoing method of selective configuration, wherein the local service image cache includes either or both a card service image cache included in the accessory module and a device service image cache included in the wireless device. The foregoing method of selective configuration, the method further comprising: uncoupling and later recoupling the accessory module and the wireless device; transmitting a modified service download request to the service server facility via the wireless access mechanism, wherein the modified service download request indicates the extent of the caching in the local service image cache; the service server facility responding to the modified service download request by selectively transmitting any non-locally-cached portions of the customized service image to the wireless device via said wireless access mechanism; and the wireless device and the accessory card in combination executing the customized service image to provide the customized service to the user, wherein subsequent to the caching the customized service image includes the cached portions and the portions that are non-locally-cached.

### DETAILED DESCRIPTION

Wireless Device and Accessory Card

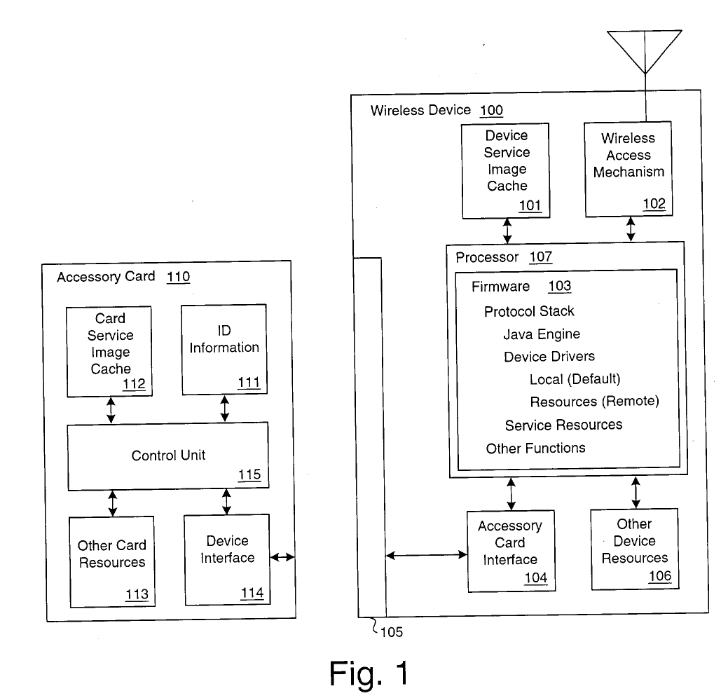

FIG. 1 illustrates a wireless device and an accessory card, in accordance with a preferred embodiment of the present invention. Wireless device 100 includes: processor 107 with included firmware 103, coupled to accessory card interface 104, wireless access mechanism 102, optional device service image cache 101, and other device resources block 106. There is also accessory card socket 105, coupled to accessory card interface 104, to provide for insertion of expansion modules such as accessory card 110. Accessory card 110 includes control unit 115, coupled to identification information providing block 111, optional card service image cache 112, device interface 114, and other card resources block 113.

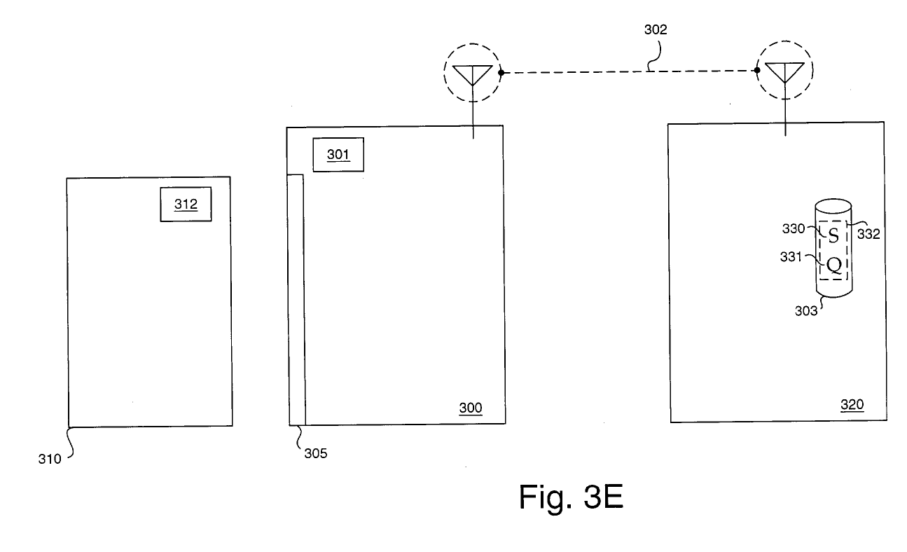

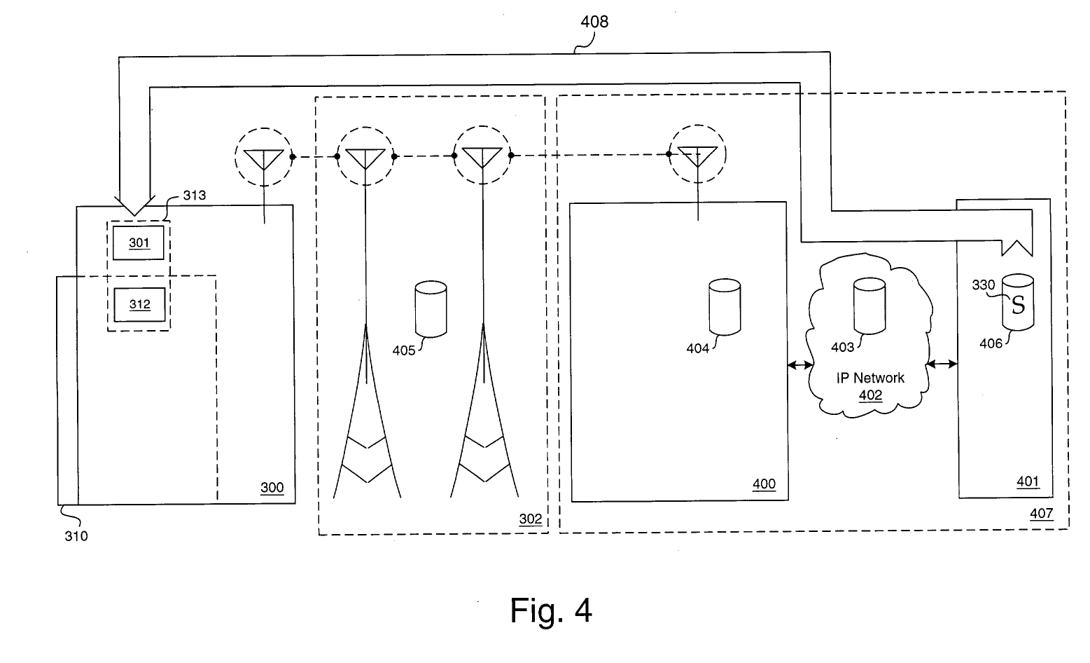

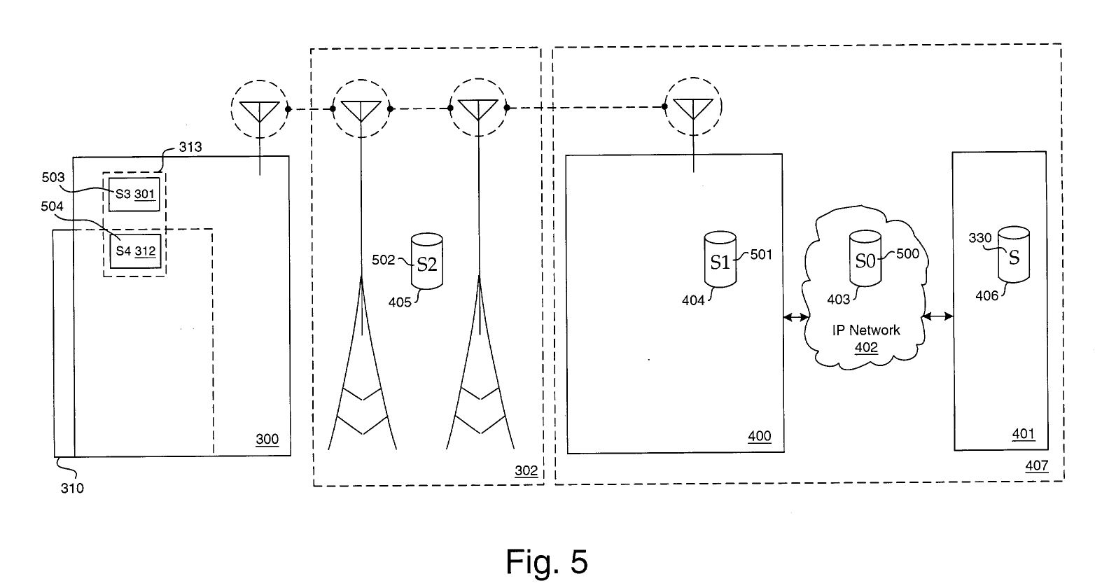

Executing on processor 107 is firmware 103 including functionality of a protocol stack and other wireless device functions. The protocol stack provides a Java engine, device drivers, and various service resources. Wireless access mechanism 102, based on the GSM standard in the preferred embodiment, provides wireless communication with service server facilities, as well as wireless communication with other wireless devices. Accessory card interface block 104 provides low-level interface mechanisms to enable communication between processor 107 executing firmware 103 and inserted accessory card 110. Device service image cache 101 provides an optional local storage for of any portion of a downloaded service image and subsequently generated service state. Firmware 103, while executing on processor 107, provides further functions for managing this cache and the card service image cache 112 in accessory card 110 (this is described in more detail in the following discussion of FIG. 4 and FIG. 5). Other device resources block 106 provides additional resources for wireless device 100, including optional storage of any portion of a downloaded service image and subsequently generated service state.

The functions of firmware 103 executing on processor 107 include the ability to recognize insertion of an accessory card into socket 105 via accessory card interface 104, interrogate identification information from identification information block 111 as needed, and request a corresponding device driver and service image download via wireless access mechanism 102. The downloaded service image is executed using resources internal to wireless device 100 as well as resources in inserted accessory card 110. The functions of firmware 103 executing on processor 107 also provide the ability to terminate the service when accessory card 110 is removed from accessory card socket 105, communicating state to the service server facility via wireless access mechanism 102 as needed.

Whenever an accessory card is inserted into accessory card socket 105, firmware 103, executing on processor 107, attempts to use wireless access mechanism 102 to download a service image. In conjunction with the service image download attempt, a device driver will be chosen from one of two categories: (1) local, and (2) resource. A local driver (also known as a default driver) is used when there is no service image available from a service server facility, such as when no service server facility can be found to download a service image, or when there is no downloadable service image available for the particular accessory card inserted. A resource type of driver (also known as a remote driver) is used when there is a service image downloadable from a service server facility and associated service provider. Execution of firmware 103 on processor 107 will further provide resources for execution of the remotely provided service image.

Those of ordinary skill in the art will appreciate that blocks 101, 107 and 104 of wireless device 100 illustrated in FIG. 1 are not necessarily implemented separately from other functions within wireless device 100, including blocks 102 and 106. FIG. 1 merely illustrates them as separate blocks to highlight these specific functions. Processor 107 embodiments include any industry standard microprocessor, or microcontroller, together with memory and appropriate glue logic. Further, processor 107 functions may alternatively be partially implemented in state machines or hard-wired logic. Those of ordinary skill in the art will also recognize that firmware 103 functions may be wholly or partially implemented directly in hardware. The partitioning shown is for illustrative purposes only. Additionally, the functionality associated with accessory card insertion and subsequent service image download, execution, and termination may be present for any number of accessory cards, whether these accessory cards are inserted individually or in any combination.

In accordance with the present invention, accessory card 110 identification information block 111 provides identification information in one or more industry standard formats specifying card and manufacturer identification information that may identify a class of cards, or instance specific information uniquely identifying a single card. Class identification information includes: type or class of service supported, vendor identification string, and revision level. Specific instance identification includes: serial number or manufacturing date code.

This ID information is communicated to wireless device 100 by accessory card device interface 114 connection via socket 105 to wireless device accessory card interface 104. It is then used by firmware 103 executing on processor 107 to request downloading of a service image, or to determine the local driver to be used in the event a service image is not downloaded. The identification information obtained from block 111 may be transmitted directly to the service server facility or it may be examined and modified in some manner by firmware 103 executing on processor 107 before transmission to the service server facility.

Card service image cache 112 provides an optional mechanism for local storage of any portion of the downloaded service image (this is described in more detail in the following discussion of FIG. 4 and FIG. 5). In the illustrated embodiment, card service image cache 112 comprises non-volatile storage, retaining information when accessory card 110 is not coupled to any wireless device. Accessory card control unit 115 coordinates and controls the activities of card service image cache 112, identification information block 111, device interface 114, and other card resources block 113, among other activities. Other card resources block 113 provides additional resources for wireless device 110, including support for control functions implemented in control unit 115, and optional storage of any portion of a downloaded service image and subsequently generated service state.

The accessory card need not be strictly inserted into the wireless device. Those of ordinary skill in the art will recognize that the accessory card may be coupled to the wireless device in any convenient manner, such as via an external accessory card interface cabled to the wireless device via an expansion bus, and may be realized in any number of form factors. Two illustrative embodiments of accessory cards are the CompactFlash card and the MultiMediaCard formats.

Those of ordinary skill in the art will appreciate that blocks 112, 111, 114, and 115 of accessory card 110 illustrated in FIG. 1 are not necessarily implemented separately from other functions within accessory card 110, including block 113. FIG. 1 merely illustrates them as separate blocks to highlight these specific functions. Control unit 115 embodiments include any industry standard microprocessor or microcontroller, with appropriate associated memory, firmware, and glue logic. Alternatively a state machine or combinations of hard-wired logic may be used, in conjunction with a microprocessor or microcontroller. The partitioning shown is for illustrative purposes only. The term cache is not meant to be restrictive to a particular implementation of storage, but is merely suggestive that the service image code and data are retained in anticipation of future use in order to improve performance.

In contemplated variations of the foregoing, control unit 115 or other card resources block 113 may include significant stand-alone processing power, either special purpose, general purpose, or both. This additional capability would be used to provide more sophisticated services than without the added resources.

Service Server Facility

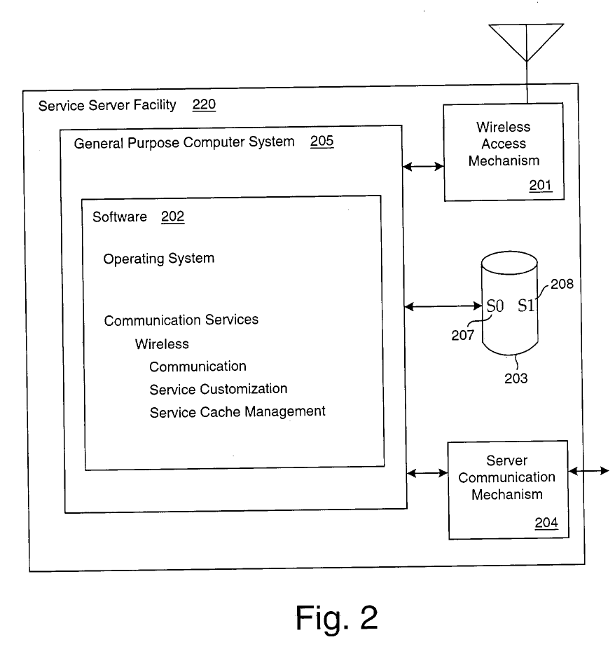

FIG. 2 illustrates a service server facility in accordance with the present invention. Service server facility 220 is the mechanism by which service providers provide services (in the form of service images) to users of these services. These services may be provided to the public in general, as subscription or pay-per-use offerings, or be restricted to use by specific customers or corporations, as proprietary services or applications. Service server facility 220 includes a general-purpose computer system 205, coupled to wireless access mechanism 201, server communication mechanism 204, and persistent storage mechanism 203.

General purpose computer system 205 frequently includes substantially more general purpose processing power than a wireless device, with sufficient capacity and capabilities to interact with many (perhaps hundreds or thousands) of wireless devices simultaneously in use by users of the provided services. In this illustrated embodiment of the present invention, general-purpose computer system 205 executes software 202 that further includes a full-featured operating system and functions for communication services. These communication services, in turn, further include wireless communication, wireless service customization, and wireless service cache management functionality (discussed in more detail, below). Illustrative examples of the full-featured operating system include Windows Server, trademarked by Microsoft Corp., and Solaris, trademarked by Sun Microsystems, Inc.

In accordance with the present invention, wireless access mechanism 201 provides a first mechanism for communication between the service server facility and wireless devices, including those in accordance with the present invention. Wireless access mechanism 201 may also optionally provide wireless communication to other service server facilities. Server communication mechanism 204 provides a second, indirect mechanism, for communicating between the service server facility and wireless devices. Here, the communications may be via a local area network (LAN), using Internet protocol over Ethernet if the distances permit, or to a wide area network (WAN), such as the Internet, and using packet over SONET if required. At least one of blocks 201 and 204 must be provided in service server facility 220, but the presence of both blocks is optional, as described below.

Persistent storage mechanism 203 is used in part for service providers to provision service server facility 220 with service images (represented as S0 207 and S1 208 in persistent storage 203, in accordance with the present invention. In the illustrated embodiment, persistent storage 203 is shown as a hard disk separate from general purpose computer system 205, but it may instead be integral to general purpose computer system 205, or in a LAN attached storage device, or in any mechanism providing long term storage of binary data that is operatively coupled to general purpose computer system 205.

As summarized above, software 202 executing on general purpose computer system 205 provides several communication services: wireless communication, wireless service customization, and wireless service cache management, all in accordance with the present invention.

The wireless communication functions include mechanisms to receive requests for service image download via wireless access mechanism 201, access stored service images from persistent storage 203, and to transmit copies of these images to the requesting wireless device via wireless access mechanism 201. There are analogous wireless communication functions to receive service image download requests and transmit accessed service images via server communication mechanism 204.

The wireless service customization functions include mechanisms to examine various factors, some of which may be received as part of the service image download request from the wireless device, and thus to modify the service image provided to the requesting wireless device, allowing selective configuration of the requested service. The request factors examined include: the particular wireless device, the specific accessory card, the individual user, the particular service server facility, and the associated service provider. This process allows full customization of the service image provided, including navigation and other aspects of the user interface, based on the examined factors.

The service image cache management functions provide for maintaining the coherence of cached copies of service image or images (this is described in more detail in the following discussion of FIG. 4 and FIG. 5).

FIG. 2 is illustrative of two classes of service server facilities, as one of ordinary skill in the art will recognize. Only one of wireless access mechanism 201 and server communication mechanism 204 are required. If the service server facility includes wireless access mechanism 201, allowing direct communication with wireless devices or wireless communication infrastructure, then for the purposes herein, it is termed a wireless service server facility. If a service server facility lacks wireless access mechanism 201, then it must include server communication mechanism 204, and for the purposes herein, it is termed a host service server facility. Such a host service server facility uses server communication mechanism 204 to communicate to a wireless service server facility or a wireless gateway to enable communication with the wireless devices through which users gain access to the services provided. If a service server facility includes wireless access mechanism 201 in addition to server communication mechanism 204, it is considered a wireless service server facility.

Those of ordinary skill in the art will recognize there are an arbitrary number of ways to implement service server facility 220. What is shown in FIG. 2 is illustrative only. It is also readily apparent that wireless access mechanism 201 and server communication mechanism 204 may be implemented using any number of readily available standard mechanisms. In addition, the functionality of persistent storage 203, general purpose computer system 205, wireless access mechanism 201, and server communication mechanism 204, may be combined or implemented in various ways sharing resources as appropriate.

Automatic Service Image Download, Activation, and Termination

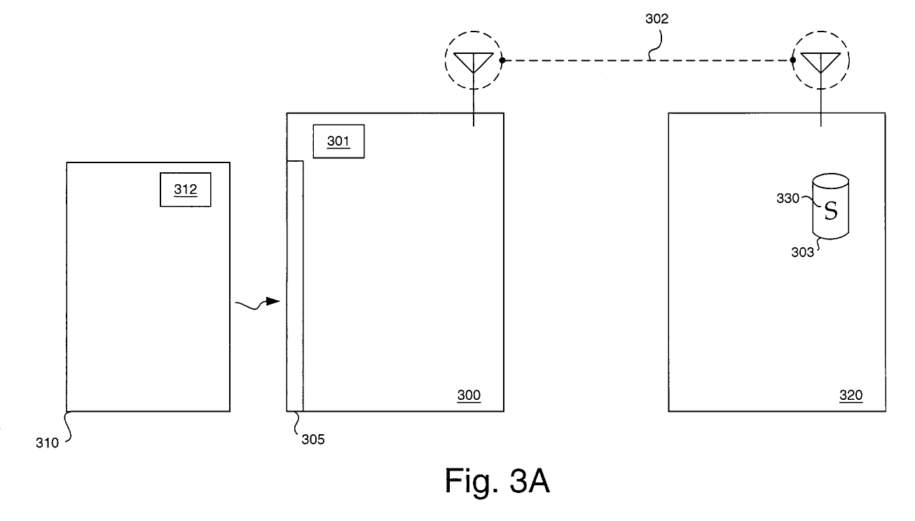

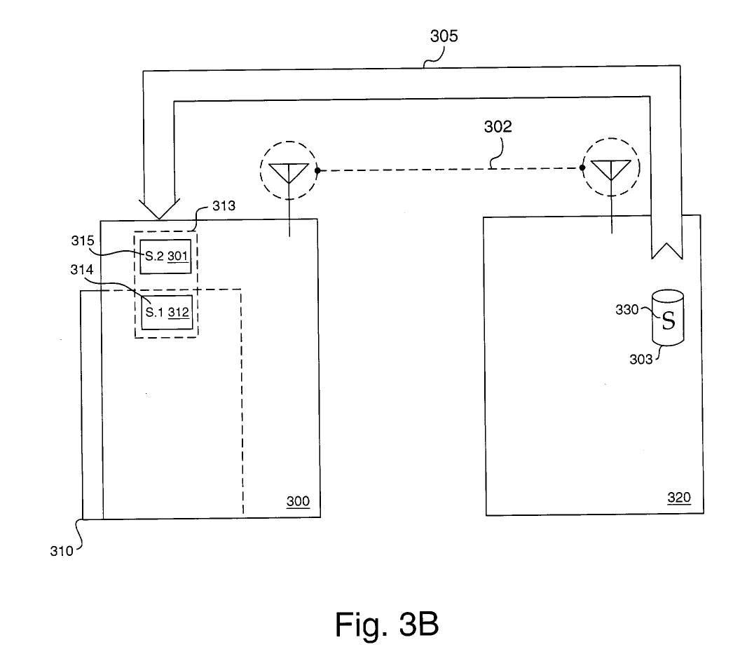

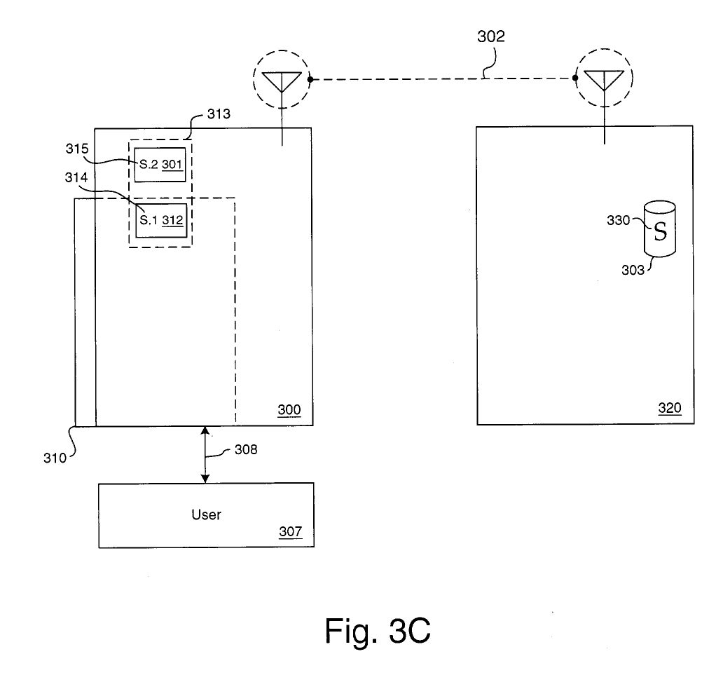

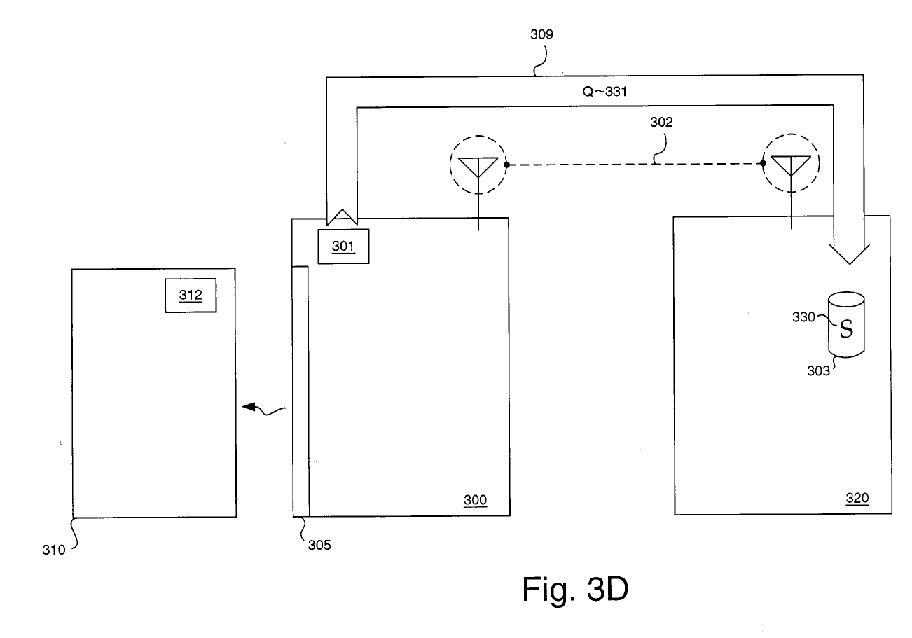

FIGS. 3A-E collectively illustrate a system supporting automatic download and activation of a service when an accessory card is inserted in a wireless device, and automatic termination of the service when the accessory card is removed, in accordance with the present invention. The operation of this aspect of the present invention is summarized as follows:
1. a user inserts an accessory card into a wireless device,
2. the wireless device automatically requests download of a service image from a service server facility,
3. as soon as possible after or during the service image download the service is automatically activated and presented to the user,
4. the user uses the service and when finished merely removes the accessory card from the wireless device, and
5. the service is automatically terminated and final service state is transmitted back to the service server facility as appropriate.

FIG. 3A illustrates a wireless device 300 (an instance of the wireless device 100 of FIG. 1), a device service image cache 301 (corresponding to an instance of block 101 in wireless device 100), a socket 305 (corresponding to an instance of socket 105 in wireless device 100) for receiving accessory card 310 (an instance of the accessory card 110 of FIG. 1), and wireless connection 302 to service server facility 320 (an instance of the service server facility 220 of FIG. 2). Service server facility 320 includes persistent storage 303 (corresponding to block 203 of service server facility 220), where service image S 330 (an instance of one of services S0 207 or S1 208 of service server facility 220) is located. Also illustrated is a card service image cache 312 in accessory card 310 (corresponding to an instance of block 112 in accessory card 110).

FIG. 3B illustrates the system of FIG. 3A after insertion of accessory card 310 into wireless device 300 and subsequent service image download. In this illustration wide arrow 305 is conceptually suggestive of the information flow associated with this service image download, and is not indicative of any particular structure, as the data corresponding to the service image downloaded is transferred over wireless connection 302. The operation is as follows. Upon insertion of accessory card 310 into wireless device 300, wireless device 300 transmits a request for a service image download appropriate to the collection of accessory card 310, wireless device 300, and any relevant user identification information. Service server facility 320 receives this download request and determines that service image S 330 is an appropriate service image, and downloads it via wireless connection 302. The service image may be selected from a collection of preexisting service images, or it may be built dynamically, either as a general function of the nature of the request or the specifics of the collection of card, device, and user, described in more detail below. The download occurs as shown conceptually by wide arrow 305. The service image is stored into the collection 313 of device service image cache 301 and card service image cache 312. This is illustrated as S.2 315 in device service image cache 301 and S.1 314 in card service image cache 312.

FIG. 3C illustrates the system of FIG. 3B after sufficient downloading to allow activation of the downloaded service image for presentation to the user. The service image stored in 313 is activated and presented to user 307 via user interaction 308. User interaction 308 generally includes, by way of example: providing data to the user in a visual or aural manner, and receiving data from the user in a tactile or verbal manner. This may be via any combination of mechanisms provided directly by the wireless device and those mechanisms provided in conjunction with the accessory card.

In this manner automatic service image download and presentation to the user is effected when an accessory card is inserted into a wireless device, in accordance with the present invention. The only user interaction required for initiation of this service activation sequence is insertion of an accessory card into a wireless device. The subsequent service image download and execution occur automatically.

In an application-specific illustrative scenario in accordance with the present invention, consider the accessory card 310 of FIGS. 3A-3C to be a bar code reader accessory card and the wireless device 300 to be a PDA. Insertion of the bar code reader card into the PDA would trigger transmission of an inventory management service into the combination of the bar code reader accessory card and the PDA. The inventory management service would be presented to the user, with no further user action required, as soon as allowed by the download process, awaiting the first use of the scanner or other input from the user. User interaction would include selection by the user of desired functionality (end of month inventory summary, for example), swiping the bar code reader on the bar codes of selected items, subsequent display of error codes when swiping was insufficient, and inventory summary information as items were swiped.

FIG. 3D and FIG. 3E collectively illustrate the system of FIGS. 3A-C with the further operation of automatic termination of the service when the accessory card is removed from the wireless device, in accordance with the present invention.

FIG. 3D illustrates the removal of accessory card 310 from wireless device 300, resulting in the termination of service provided to the user. Part of the tear-down and clean-up of the service may require transmission of final state to the service server facility. In this illustration wide arrow 309 is conceptually suggestive of the primary information flow associated with this final state transmission, and is not indicative of any particular structure, as the data corresponding to final state transmission is transferred over wireless connection 302. The operation is as follows. When the user completes use of the provided service, the user removes accessory card 310 from wireless device 300. Wireless device 300 deactivates the service, freeing up resources, and if necessary, transmits final service state Q 331 to service server facility 320 via wireless connection 302 (illustrated conceptually as wide arrow 309). The only user action required to initiate this process is to remove accessory card 310 from wireless device 300.

FIG. 3E illustrates the system of FIG. 3D after completing the transfer of final service state Q 331 to service server facility 320. Final service state Q 331 is stored in persistent storage 303, along with original service image S 330. In some service applications, final service state Q 331 is integral to the provided service, and thus the collection 332 of service image S 330 and final service state Q 331 represents a modified service image to be downloaded the next time the service is activated by insertion of accessory card 310 into wireless device 300. In other service applications final service state Q 331 is independent of the service image to download, and service image S 330 is downloaded without modification the next time the service is activated by insertion of accessory card 310 into wireless device 300.

In this manner the user intervention required to activate and deactivate a service enabled by an accessory card in conjunction with a wireless device is reduced to the effort needed to insert and remove the accessory card.

In a first illustrative embodiment, services automatically downloaded transmit state to the service server facility as the service is used, in near real-time, and no final transmission of state is required when the accessory card is removed from the wireless device. In a second illustrative embodiment, state is transmitted to the service server facility only after the accessory card is removed. In a third illustrative embodiment state is transmitted partially during service use and partially after removal of the accessory card from the wireless device. It will be recognized by those of ordinary skill in the art that the illustrated storage of the downloaded service image in both card service image cache 312 and device service image cache 301 is an illustrative embodiment only. It is merely sufficient to store the service image in a manner accessible by the resources executing the service as provided in the combination of accessory card 310 and wireless device 300. This may be satisfied by storing the image solely in card service image cache 312, solely in device service image cache 301, solely in other cards resources block 113, solely in other device resources block 106, or distributed between 312, 301, 113, or 106 in any arbitrary manner. Hence, in a given implementation, service image cache 312 and device service image cache 301 are optional, as previously described. In the second or third illustrative embodiments described above (where final service state Q 331 is returned after removal of accessory card 310 from wireless device 300), final service state Q 331 would be stored in device image cache 301 just prior to transmission to service server facility 320, since accessory card 310 is removed from wireless device and is thus not available to provide final service state Q 331 for transmission to service server facility 320.

In the previously described application-specific scenario in accordance with the present invention, (bar code scanner accessory card and a PDA), when the bar code accessory card is removed from the PDA, the inventory management service terminates, resources used by the service are freed up, and the PDA reverts to the state before the insertion of the accessory card. The next time the bar code accessory card is inserted into the PDA the identical inventory management service image is downloaded into the combination of the bar code accessory card and PDA. As a value-added feature, the inventory management system stores final service state indicative of the last item scanned (so the user could resume previously begun work from the same point). In this scenario, the service image downloaded varies from one time to the next, including information derived from the final state of the inventory management service (where the user previously ceased work and removed the bar code scanner accessory card).

Service Image Caching

FIG. 4 and FIG. 5 collectively illustrate using caching mechanisms to reduce the time between accessory card insertion and availability of the enabled service to the user, as an enhancement of the present invention. Service image code and data are stored along the communication path from the source service server facility and the destination wireless device, to improve service image download performance.

FIG. 4 expands upon the wireless system of FIGS. 3A-3E, illustrating a service image download, including details of the wireless and server communication infrastructures. In this illustration wide arrow 408 is conceptually suggestive of the primary information flow associated with service image downloading, and is not indicative of any particular structure, as the corresponding data is transferred via wireless connection 302 and IP network 402.

Accessory card 310 is illustrated inserted into wireless device 300. Wireless connection 302 includes several individual wireless connections and persistent storage 405, and couples wireless device 300 to collection 407. Collection 407 consists of a wireless gateway 400, coupled to IP network 402, and a host service server facility 401 (an instance of the service server facility 220 of FIG. 2, with a server communication mechanism but no wireless access mechanism) also coupled to IP network 402. Wireless gateway 400 includes persistent storage 404 (corresponding to an instance of block 203 in service server facility 220). Host service server facility 401 includes persistent storage 406 (corresponding to an instance of block 203 in service server facility 220). Persistent storage 406 is where service image S 330 is located.

The following occurs when accessory card 310 is inserted into wireless device 300:
1. wireless device 300 recognizes insertion of accessory card 310, and interrogates it for identification information,
2. wireless device 300 requests a service image appropriate for accessory card 310 from host service server facility 401, including in the request the returned identification information from accessory card 310, via wireless communication infrastructure 302 through wireless gateway 400 and IP network 402,
3. host service server facility 401 sends a copy of service image S 330 to wireless gateway 400 via IP network 402,
4. wireless gateway 400 in turn transmits the copy of service image S 330 to wireless device 300 via wireless communication infrastructure 302,
5. wireless device 300 stores the downloaded copy of service image S 330 into collection 313 as necessary for service activation, and
6. the combination of wireless device 300 and accessory card 310 executes the copy of downloaded service image S 330 as soon as possible and presents the resulting service to the user.

Items 3-5, above, are illustrated conceptually by wide arrow 408, indicating download of service image S 330 from host service server facility 401 over IP network 402 and wireless connection 302 into collection 313.

FIG. 5 further illustrates the wireless system of FIG. 4, showing caching of service image information between the source host service server facility 401 and the destination wireless device 300 with accessory card 310. Consider that all or portions of the service image download copy may be stored at intermediate points along the path from the source to the destination. This is shown as S0 500 within the IP network 402, S1 501 within wireless gateway 400, S2 502 within wireless connection 302, S3 503 stored in device image cache 301, and S4 504 stored in card image cache 312. Each of the components in the path from the source to the destination may store a copy of any portion of the service image, so that download 408 (illustrated in FIG. 4) will require less time than without the caching. This in turn allows presentation of the downloaded service to the user in less time than without the caching.

Standard cache coherency protocols used with Internet content may be used to keep S0 500, S1 501, S2 502, S3 503, and S4 504 up to date or invalidated, as appropriate. In the preferred embodiment, collection 313 is operable to store an entire copy of service image S 330. Thus when accessory card 310 is inserted into wireless device 300, the download request and return information is reduced to a check of the proper coherency of the cached information in collection 313 (the card service image cache 312 and the device service image cache 301), rather than a complete download of a copy of service image S 330. Those of ordinary skill in the art will recognize this technique is readily applied no matter how the storage of the copy of the service image is partitioned between the elements of collection 313.

Similarly, service state transmitted back from the combination of accessory card 310 and wireless device 300 (as a result of providing the service to the user) may also be cached in wireless connection 302, wireless gateway 400, and IP network 402, using the same Internet content caching protocols as the initial service image download.

In the previously described application-specific scenario in accordance with the present invention, (bar code scanner accessory card and a PDA), the PDA would store a copy of the inventory management service image, updating it only when the standard caching infrastructure indicated the cached copy was out of date. In this way the inventory management service image provided upon insertion of the bar code scanner accessory card would be available to the user in substantially less time than without the use of the cache mechanisms.

In the more general scenario of this performance enhancement, the wireless device may retain local copies of any portion of the service images (code and data) for multiple accessory cards. Cache coherence is maintained via the wireless connection in the wireless device. In this manner the time between an accessory card insertion into a wireless device and the subsequent availability to the user of the downloaded service image is minimized.

Those of ordinary skill in the art will also recognize that although the present embodiment is described in terms of Internet caching protocols, any caching protocol appropriate to the given communication infrastructure and associated protocol or protocols may be used.

Those of ordinary skill in the art will also appreciate that the wireless and server communication infrastructures may be arbitrarily more complex than those illustrated in FIG. 4 and FIG. 5. The total communication pathway between the combination of an accessory card and a wireless device to a host service server facility may include several sections of wireless communication in series with one or more sections of IP networking. In addition, wireless communication infrastructures by themselves may be partially composed of server communication infrastructures, and server communication infrastructures may also be partially composed of wireless sections. The present invention contemplates and encompasses these various scenarios.

Service Image Customization

The present invention described thus far may be summarized as an automatic download, activation, and termination of a service when an accessory card is inserted and removed from a wireless device. A further refinement, in accordance with the present invention, customizes the downloaded service image and associated user interface based on several factors: the particular wireless device, specific accessory card, individual user, particular service server facility, and associated service provider. This is accomplished by the download request from the wireless device identifying the specific wireless device, the specific inserted accessory card, and including any login or other user identification information available in the device. The service server facility then examines this information in the download request, along with additional information specific to the particular service server facility and the provider of the specific service image itself, to determine appropriate customization of the requested service image and associated user interface. The customization is effected by providing a modified copy of the service image, altered according to the desired customization, to the requesting wireless device, where it is stored appropriately in the wireless device and inserted accessory card. As soon as possible during the download and storage of the modified service image in the wireless device and accessory card, the service is activated and presented to the user, with no other user action other than insertion of the accessory card into the wireless device.

Relating to this refinement, it is necessary to understand the process of provisioning a service server facility with one or more service images. This provisioning process includes providing, by any procedure, the binary information forming the image of the service (code and data), and configuring the service server facility containing the service image accordingly. The configuring process includes enabling the service server facility communication services software, previously described, to recognize opportunities to customize and download service images in accordance with the present invention. A service provider, such as the accessory card manufacturer or a value-added reseller, sources the service image and the associated configuration is performed at the request of the service provider. This results in a service image, as delivered by the service provider, available for customization, download, and presentation to the user according to the direction of the service provider, in the manner described above.

Understanding the service image and user interface customization is facilitated by way of application-specific illustrative scenarios. As an introduction, consider embodying this customization refinement in the previously described application-specific scenario in accordance with the present invention (bar code scanner accessory card and a PDA). The inventory management service image downloaded into the combination of the PDA and the bar code scanner is customized according to whether the user is a stocker or a manager. The inventory management service user interface to a stocker class user allows only inventory information collection, while the user interface to a manager class user allows ordering of new supplies.

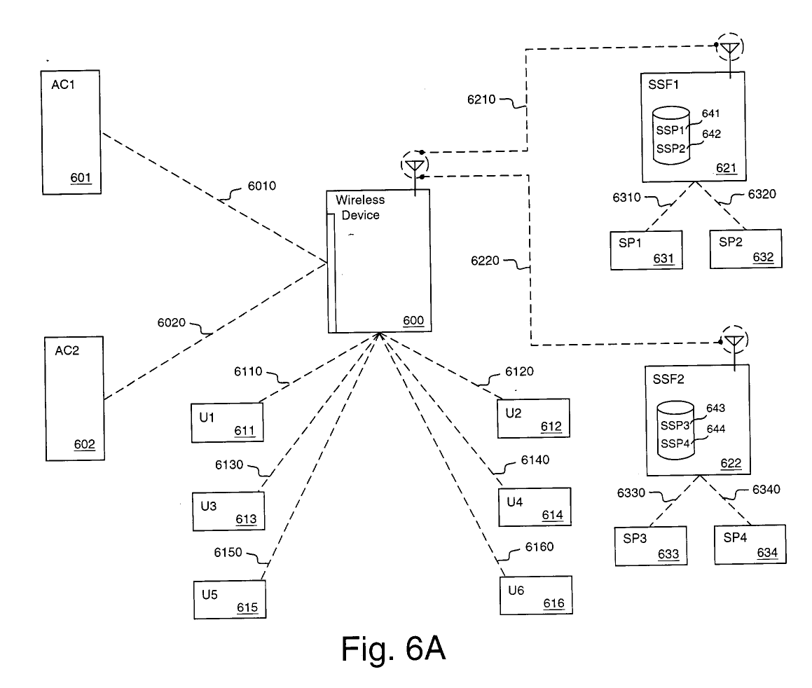

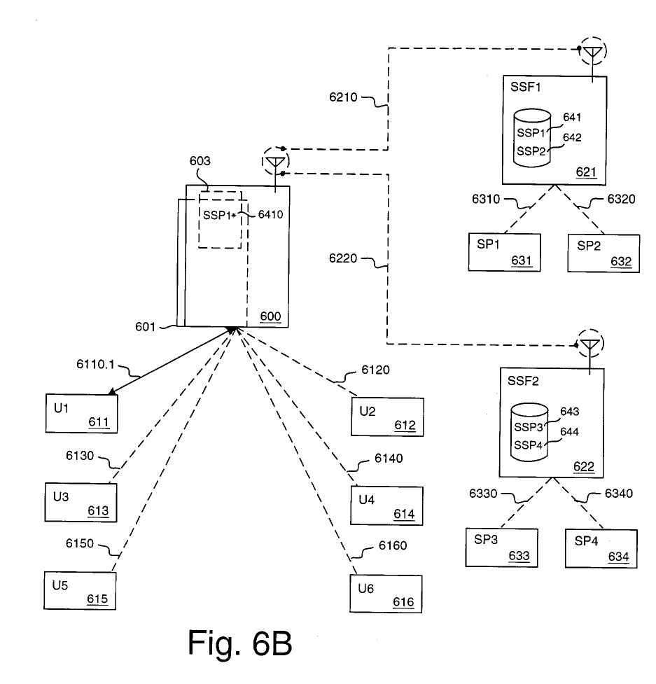

Further application-specific illustrative scenarios are presented in the following table, with cross-references to element identifiers in accompanying FIG. 6A and FIG. 6B. The table illustrates service image and associated interface customization in the embodiment wherein the wireless device is a PDA.

Table Of Service Image Customization Illustrative Scenarios

| Accessory | | | |
|---|---|---|---|
| Card | Service | User | Customization |
| Bar Code | Corporate Inven- | Stocker 611 | Input current inven- |
| Scanner 601 | tory Management | | tory (only) 6410 |
| | Software | Manager 612 | Input current inven- |
| | 641 | | tory, order addition- |
| | | | al inventory |
| | Price Comparison | English | Price comparison |
| | Service 642 | Customer 613 | service in English |
| | | Chinese | Price comparison |
| | | Customer 614 | service in Chinese |
| Gaming | Role Playing | Novice Player | Novice level role |
| Interface 602 | Entertainment | 615 | playing games |
| | 643 | Expert Player | Expert level role |
| | | 616 | playing games |
| | Sports Games 644 | Novice Player | Beginner sports |
| | | 615 | games |
| | | Expert Player | Expert sports games |
| | | 616 | |

Consider the application-specific scenarios illustrated by the table and FIG. 6A, in accordance with the present invention. The wireless device WD 600 is a PDA (an instance of the wireless device 100 of FIG. 1). Wireless device WD 600 is alternately coupled (shown as 6010 and 6020, respectively) to two accessory cards AC1 601 (a bar code scanner as shown in the table) and AC2 602 (a gaming interface as shown in the table). Accessory cards AC1 601 and AC2 602 are instances of the accessory card 110 of FIG. 1. In the embodiment illustrated by FIG. 6A, only one of accessory cards AC1 601 and AC2 602 are inserted into wireless device WD 600 at a time.

Six users illustrated as: U1 611 (a stocker as shown in the table), U2 612 (a manager as shown in the table), U3 613 (an English customer as shown in the table), U4 614 (a Chinese customer as shown in the table), U5 615 (a novice player as shown in the table), and U6 616 (an expert player as shown in the table), are also alternately coupled to wireless device WD 600 (shown as 6110, 6120, 6130, 6140, 6150, and 6160, respectively). In this illustrated embodiment only one of these six users at a time is actively engaged with wireless device WD 600.

Wireless device WD 600 is also coupled to two service server facilities SSF1 621 and SSF2 622, via wireless connections 6210 and 6220, respectively. Service server facilities SSF1 621 and SSF2 622 are instances of the service server facility 220 of FIG. 2. In this illustrated embodiment wireless connections 6210 and 6220 are simultaneously active.

Provisioning of service images SSP1 641 and SSP2 642 in service server facility SSF1 621 is performed by service providers SP1 631 and SP2 632, respectively. This is indicated in FIG. 6A by dashed lines 6310 and 6320, respectively. Similarly, provisioning of service images SSP3 643 and SSP4 644 in service server facility SSF2 622 is performed by service providers SP3 633 and SP4 634, respectively. This is indicated in FIG. 6A by dashed lines 6330 and 6340, respectively. As shown in the table, service image SSP1 641 is corporate inventory management software, SSP2 642 is a price comparison service, SSP3 643 is role playing entertainment, and SSP4 644 is sports games.

Further consider the application-specific scenario detailed in the first row of the table and illustrated in FIG. 6B, in accordance with the present invention. Stocker user 611 inserts bar code scanner accessory card 601 into PDA wireless device 600 thereby initiating an automatic customization, download, and activation of corporate inventory management software service image 641. This begins by PDA 600 transmitting a request for a download of a service image appropriate to bar code scanner 601 as used by stocker 611 when inserted into PDA 600. Service server facility SSF1 621 responds to this request after determining that the corporate inventory management software embodied as service image SSP1 641 is appropriate for PDA 600 with bar code scanner 601 when used by stocker 611. Service server facility SSF1 621 then accesses service image SSP1 641 and modifies a copy of it so that only inventory input functions are available, removing or disabling the inventory ordering functions, and then transmits the modified image copy to PDA 600 via wireless connection 6210. PDA 600, in conjunction with bar code scanner 601, stores the modified service image as SSP1* 6410 in collection 603. As soon as possible during download and storage of modified service image 6410, the service image is activated and presented to user 611 via active user interaction 6110.1. As illustrated in FIG. 6B, collection 603 is analogous to collection 313 of FIG. 3B, corresponding to the collection of the card service image cache of bar code scanner 601 and the device service image cache of PDA 600.

In a similar manner the remaining seven rows of the table illustrate application-specific scenarios with customization of the server and associated user interface as a function of the particular wireless device, specific accessory card, individual user, particular service server facility, and associated service provider. The second row illustrates the customization of the inventory management software 641 to enable inventory-ordering functions when used by manager 612. The third and fourth rows of the table illustrate the scenario where bar code scanner 601 insertion into PDA 600 initiates download of price comparison service image 642, customized according to the language of the customer. English customer 613 and Chinese customer 614 are presented menus and other navigation information in English and Chinese, respectively, and resultant price comparisons of scanned items are presented in these two languages appropriately. Service server facility SSF1 responds to the download request, with appropriate customization, based partially on consideration of user identification as English customer 613 or Chinese customer 614, as communicated in the download request for a service image appropriate to bar code scanner 601 when inserted into PDA 600.

Similarly, the bottom four rows of the table illustrate application scenarios when gaming interface 602 is inserted by either novice player 615 or expert player 616 into PDA 600. In either situation PDA 600 transmits a download request, on wireless connections 6210 and 6220 to service server facilities SSF1 1621 and SSF2 622, respectively, identifying the user, accessory card, and wireless device. In these scenarios service server facility SFF2 622 responds as it recognizes role-playing entertainment service image 643 and sports gaines service image 644 as appropriate to the combination of gaming interface 602 and PDA 600. Service server facility SSF2 622 chooses between entertainment service image 643 and sports image 644 based on configuration information provided by service providers 633 and 634. In this embodiment the selection is based on the time of day: midnight through noon role playing entertainment service image 643 is selected and sports gaines service image 644 is selected otherwise. Following selection of either service image 643 or 644 according to these criteria, the user identification information is examined and the skill level of the user ascertained. A copy of the selected service image is modified to operate at the appropriate skill level and downloaded to PDA 600, where it is activated and presented to the user as soon as possible and with no further user intervention.

Those of ordinary skill in the art will recognize that these are illustrative application-specific scenarios only, and that the concept of customizing the service image and associated interface as a function of the given wireless device, the given accessory card, the given user, the given service server facility, and the associated service provider may be applied to any manner of services, wireless devices, accessory cards, users, service server facilities, and associated service providers. It is also possible to group or categorize each of these determining factors as part of the customization process. All users in a specific country, for example, may be treated identically with respect to service image and interface customization, or each and every individual user may be treated uniquely, or any possibility in between. Similar approaches may be used with respect to the given wireless device, the accessory card, the service server facility, and the service provider.

It will also be readily apparent to those of ordinary skill in the art that FIG. 6A and FIG. 6B are illustrative only, particularly with respect to the simultaneous activity of wireless connections 6210 and 6220. Wireless device 600, in another embodiment, would be enabled to recognize which service server facility was appropriate for a given inserted accessory card, and enable wireless connectivity appropriately. Thus there is no requirement for simultaneous connectivity to any particular plurality of possible service server facilities.

Furthermore, the present invention is not in any way limited to insertion and removal of a single accessory card into a wireless device. Insertion of a plurality of cards, whereby insertion of each card is followed by automatic customized service download and activation, and then termination when the corresponding accessory card is removed, is further contemplated. Thus a first card may be inserted, resulting in a first customized service image download and presentation to a user. This may then be followed by a second card insertion, resulting in a second customized service image download and presentation to the user. At this time the first and second customized services are simultaneously active and available to the user. Subsequently the first card may be removed, resulting in termination of the first customized service but with the second customized service remaining active. Any arbitrary number of card insertions and removals may be supported in a similar fashion.

In this manner insertion of an accessory card into a wireless device results in an automatic download of a customized service image, activation of the customized service and presentation to the user, followed by termination of the service when the accessory card is removed, where the only user action required is insertion and removal of the accessory card. Further, the customized service image is tailored according to the particular wireless device, specific accessory card, individual user, particular service server facility, and associated service provider.

### CONCLUSION

Although the present invention has been described using particular illustrative embodiments, it will be understood that many variations in construction, arrangement and use are possible consistent with the teachings and within the scope of the invention. For example, interconnect and function-unit bit-widths, clock speeds, and the type of technology used may generally be varied in each component block of the invention. Also, unless specifically stated to the contrary, the value ranges specified, the maximum and minimum values used, or other particular specifications are merely those of the illustrative or preferred embodiments, can be expected to track improvements and changes in implementation technology, and should not be construed as limitations of the invention. Functionally equivalent techniques known to those of ordinary skill in the art may be employed instead of those illustrated to implement various components or sub-systems. It is also understood that many design functional aspects may be carried out in either hardware (i.e., generally dedicated circuitry) or software (i.e., via some manner of programmed controller or processor), as a function of implementation dependent design constraints and the technology trends of faster processing (which facilitates migration of functions previously in hardware into software) and higher integration density (which facilitates migration of functions previously in software into hardware). Specific variations within the scope of the invention include, but are not limited to: the type of wireless device, the type of accessory card, the mechanism and infrastructure for wireless access, the service image provided, the wireless service server facility, the server communication infrastructure, the host service server facilities, and the associated service providers.

All such variations in design comprise insubstantial changes over the teachings conveyed by the illustrative embodiments. The names given to interconnect, components, functions, circuitry, and logic are illustrative, and should not be construed as limiting the invention. E.g., although the term “accessory card” has been used in the illustrative embodiments, those skilled in the art will appreciate that the invention can be practiced with a variety of expansion module types. It is also understood that the invention has broad applicability to other wireless applications, and is not limited to the particular application or industry of the illustrated embodiments. The present invention is thus to be construed as including all possible modifications and variations encompassed within the scope of the appended claims.

1. A method of selective configuration, the method comprising:
coupling an accessory module to a wireless device;
the wireless device obtaining identification information from the accessory module;
the wireless device transmitting a service download request to a service server facility via a wireless access mechanism, the service download request including the identification information and the service server facility having access to a plurality of service images;
the service server facility responding to the service download request by selecting a first service image from the plurality of service images, the selecting being at least partially based on the identification information in the service download request;
transmitting the first service image to the wireless device via said wireless access mechanism; and
the wireless device and the accessory module in combination executing the first service image to provide a corresponding first service to a user of the wireless device and the accessory module.

2. The method of selective configuration of claim 1, further wherein the wireless device and the accessory module stop executing the first service image upon uncoupling of the accessory module from the wireless device.

3. The method of selective configuration of claim 1, the method further including caching at least a first portion of the first service image in a local service image cache, the local service image cache being local to the user.

4. The method of selective configuration of claim 3, wherein the local service image cache includes a card service image cache included in the accessory module.

5. The method of selective configuration of claim 3, wherein the local service image cache includes a device service image cache included in the wireless device.

6. The method of selective configuration of claim 4, wherein the local service image cache further includes a device service image cache included in the wireless device.

7. The method of selective configuration of claim 3, the method further comprising:
uncoupling and later recoupling the accessory module and the wireless device;
transmitting a modified service download request to the service server facility via the wireless access mechanism, wherein the modified service download request indicates the extent of the caching in the local service image cache;
the service server facility responding to the modified service download request by selectively transmitting any non-locally-cached portions of the first service image to the wireless device via said wireless access mechanism; and
the wireless device and the accessory card in combination executing the first service image to provide the first service to the user, wherein subsequent to the caching the first service image includes the cached portions and the portions that are non-locally-cached.

8. A method of selective configuration, the method comprising:
coupling an accessory module to a wireless device;
the wireless device obtaining identification information from the accessory module;
the wireless device transmitting a service download request to a service server facility via a wireless access mechanism, the service download request including:
login information identifying a user of the wireless device,
information identifying the wireless device, and
information identifying the accessory module;
the service server facility responding to the service download request by dynamically constructing a customized service image based on at least some of the information provided in the service request;
transmitting the customized service image to the wireless device via said wireless access mechanism; and
the wireless device and the accessory module in combination executing the customized service image to provide a corresponding customized service to the user of the wireless device and the accessory module.

9. The method of selective configuration of claim 8, further wherein the wireless device and the accessory module stop executing the customized service image upon uncoupling of the accessory module from the wireless device.

10. The method of selective configuration of claim 8, the method further including caching at least a first portion of the customized service image in a local service image cache, the local service image cache being local to the user.

11. The method of selective configuration of claim 10, wherein the local service image cache includes a card service image cache included in the accessory module.

12. The method of selective configuration of claim 10, wherein the local service image cache includes a device service image cache included in the wireless device.

13. The method of selective configuration of claim 11, wherein the local service image cache further includes a device service image cache included in the wireless device.

14. The method of selective configuration of claim 10, the method further comprising:
uncoupling and later recoupling the accessory module and the wireless device;
transmitting a modified service download request to the service server facility via the wireless access mechanism, wherein the modified service download request indicates the extent of the caching in the local service image cache;
the service server facility responding to the modified service download request by selectively transmitting any non-locally-cached portions of the customized service image to the wireless device via said wireless access mechanism; and
the wireless device and the accessory card in combination executing the customized service image to provide the customized service to the user, wherein subsequent to the caching the customized service image includes the cached portions and the portions that are non-locally-cached.

15. The method of selective configuration of claim 2, further comprising:
subsequent to the stopping of execution of the first service image, transmitting final service state associated with the first service to the service server facility via said wireless access mechanism.

16. The method of selective configuration of claim 8, wherein the act of dynamically constructing the customized service image is further based at least in part on configuration information stored in the service server facility.

17. The method of selective configuration of claim 9, further comprising:
subsequent to the stopping of execution of the customized service image, transmitting final service state associated with the customized service to the service server facility via said wireless access mechanism.

18. A method of operating a service server facility for selective configuration, the method comprising:
receiving a first service download request from a first wireless device of a plurality of wireless devices, the first wireless device having sent the request upon coupling with a first one of a plurality of accessory cards;
determining if at least a selected first one of a plurality of stored service images is an appropriate response to the first service download request; and
communicating to the first wireless device a first download image based at least in part on the selected first stored service image.

19. The method of claim 18, wherein the first download image includes the selected first stored service image.

20. The method of claim 18, wherein:
the first service download request includes at least a first specification of a plurality of download request specifications; and
the first download image is a customized version of the selected first stored service image, the customized version being based at least in part on at least a first parameter of a plurality of customization parameters and at least in part on information included in the first specification.

21. The method of claim 20, wherein:
each specification is selected from a download request specification set that includes:
an indication of caching extent,
login information applicable to identify one of a plurality of users,
accessory card identification information applicable to identify the first accessory card, and
wireless device identification information applicable to identify the first wireless device; and
each parameter is selected from a customization parameter set that includes:
configuration information locally available to the service server facility,
the indicated cache extent,
the identified user,
the identified accessory card, and
the identified wireless device.

22. The method of claim 21, wherein the customized version includes a subset of the selected first stored service image, the subset selected based at least in part on the indicated cache extent.

23. The method of claim 18, further comprising:
maintaining cache coherence of the first download image with respect to a local service image cache included in a combination of the first wireless device and the first accessory card.

24. The method of claim 18, further comprising:
receiving a second service download request from the first wireless device, the first wireless device having sent the second request upon coupling with a second one of the accessory cards;
determining if at least a selected second one of the stored service images is an appropriate response to the second & service download request; and
communicating to the first wireless device a second download image based at least in part on the selected second stored service image.

25. A wireless device for selective coupling with an accessory card, the wireless device including:
a processor;
a wireless access circuit coupled to the processor;
an accessory card interface coupled to the processor;
firmware executed under control of the processor; and
wherein the firmware supports:
recognition of the coupling of the accessory card to the accessory card interface,
interrogation of identification information from the accessory card via the accessory card interface,
transmission of a service image download request via the wireless access circuit, the request including at least a portion of the identification information, and
reception of a service image responsive to the service image download request via the wireless access circuit.

26. The wireless device of claim 25, wherein the firmware further supports execution of the service image at least in part via resources native to the wireless device, the service image execution providing a service to a user of the wireless device.

27. The wireless device of claim 26, wherein the firmware further supports execution of the service image at least in part via resources included in the accessory card.

28. The wireless device of claim 26, wherein the firmware further supports recognition of an uncoupling of the accessory card from the accessory card interface.

29. The wireless device of claim 28, wherein the firmware further supports cessation of the execution of the service image upon the recognition of an uncoupling of the accessory card.

30. The wireless device of claim 26, wherein the firmware further supports:
storage of at least a portion of the service image in a local service image cache within the wireless device, and
coherence maintenance operative on the local service image cache to maintain its coherence with respect to a remote service image, the coherence maintenance being performed via cache management protocols transacted over the wireless access circuit.

31. The wireless device of claim 30, wherein the firmware further supports:
transmission of a modified service image download request indicating an extent of caching in the local service image cache,
reception of a modified service image responsive to the modified service image download request via the wireless access circuit,
association of a coalesced service image as a combination of the modified service image and the portion of the service image in the local service image cache, and
execution of the coalesced service image at least in part via resources native to the wireless device, the coalesced service image execution providing the service to the user of the wireless device.

32. The wireless device of claim 31, wherein the firmware further supports:
recognition of an uncoupling of the accessory card from the accessory card interface, and
cessation of the execution of the coalesced service image upon the recognition of an uncoupling of the accessory card.

33. The wireless device of claim 32, wherein the firmware further supports returning of final service state associated with the service via the wireless access circuit subsequent to the cessation of the execution of the coalesced service image.

34. The wireless device of claim 33, wherein the firmware further supports returning of incremental service state modifications associated with the service via the wireless access circuit prior to the cessation of the execution of the coalesced service image.

35. The wireless device of claim 31, wherein the firmware further supports execution of the coalesced service image at least in part via resources included in the accessory card.

36. The wireless device of claim 30, wherein:
a device service image cache is included in the wireless device; and
the coherence maintenance operative on the local service image cache is further operative on the device service image cache.

37. The wireless device of claim 30, wherein:
a card service image cache is included in the accessory card; and
the coherence maintenance operative on the local service image cache is further operative on the card service image cache while the accessory card is coupled to the accessory card interface.

38. The wireless device of claim 25, wherein the service image download request further includes login information applicable to identify a user of the wireless device.

39. The wireless device of claim 25, wherein the service image download request further includes wireless device information applicable to identify the wireless device.

40. The wireless device of claim 26, wherein the service image download request further includes login information applicable to identify the user of the wireless device.

41. An accessory card for operation coupled to a wireless device and in conjunction with a service server facility, the accessory card including:
a device interface adapted to interface to the wireless device;
a card service image cache;
a control unit coupled to the device interface and the card service image cache; and
wherein upon coupling the accessory card with the wireless device, the control unit stores into the card service image cache at least a portion of a service image provided by the service server facility and otherwise manages the card service image cache in response to commands and data communicated from the wireless device via the device interface.

42. A service server facility for operation with a plurality of wireless devices, the service server facility including:
a general purpose computer system;
a storage unit coupled to the general purpose computer system, the storage unit including a plurality of stored service images;
a communication mechanism coupled to the general purpose computer system; and
wherein software executed by the general purpose computer supports:
reception and interpretation of service download requests, each service download request being received via the communication mechanism from a corresponding one of the wireless devices upon coupling the corresponding wireless device with a corresponding accessory card,
selection of one of the service images of the plurality of service images in response to each service download request, and
transmission of each selected service image via the communication mechanism to the corresponding wireless device.

43. The service server facility of claim 42, wherein the communication mechanism includes a wireless communication mechanism.

44. The service server facility of claim 42, wherein the communication mechanism includes a server communication mechanism.

45. The service server facility of claim 42, wherein the selected service image is selected based at least in part on user login information included in the download request.

46. The service server facility of claim 42, wherein:
each download request includes identification information applicable to identify one of a plurality of accessory cards; and
each selected service image is selected based at least in part on the identified accessory card.

47. The service server facility of claim 42, wherein:
each download request includes identification information applicable to identify the corresponding wireless device; and
each selected service image is selected based at least in part on the identified corresponding wireless device.

48. The service server facility of claim 42, wherein:
each download request includes:
login information applicable to identify one of a plurality of users,
accessory card identification information applicable to identify one of a plurality of accessory cards, and
wireless device identification information applicable to identify the corresponding wireless device; and
the selected service image is selected based at least in part on at least one criteria selected from a set of criteria including:
the identified user,
the identified accessory card, and
the identified wireless device.

49. The service server facility of claim 42, wherein:
each download request includes an indication of caching extent; and
the software further supports transmission of a subset of each selected service image via the communication mechanism to the corresponding wireless device, the subset selected based at least in part on the indication of caching extent.

50. The service server facility of claim 49, wherein the selected service image is selected at least in part based on user login information included in the download request.

51. The service server facility of claim 49, wherein:
each download request includes identification information applicable to identify one of a plurality of accessory cards; and
each selected service image is determined based at least in part on the identified accessory card.

52. The service server facility of claim 49, wherein:
each download request includes identification information applicable to identify the corresponding wireless device; and
each selected service image is selected based at least in part on the identified corresponding wireless device.

53. The service server facility of claim 49, wherein:
each download request includes:
login information applicable to identify one of a plurality of users,
accessory card identification information applicable to identify one of a plurality of accessory cards, and
wireless device identification information applicable to identify the corresponding wireless device; and
the selected service image is selected based at least in part on at least one criteria selected from a set of criteria including:
the identified user,
the identified accessory card, and
the identified wireless device.

54. A service server facility for operation with a plurality of wireless devices, the service server facility including:
a general purpose computer system;
a storage unit coupled to the general purpose computer system, the storage unit including a plurality of stored service images;
a communication mechanism coupled to the general purpose computer system; and
wherein software executed by the general purpose computer supports:
reception and interpretation of service download requests, each service download request being received via the communication mechanism from a corresponding one of the wireless devices upon coupling the corresponding wireless device with a corresponding accessory card,
selection and customization of one of the plurality of service images in response to each service download request, and
transmission of each selected service image via the communication mechanism to the corresponding wireless device.

55. The service server facility of claim 54, wherein the communication mechanism includes a wireless communication mechanism.

56. The service server facility of claim 54, wherein the communication mechanism includes a server communication mechanism.

57. The service server facility of claim 54, wherein the selected service image is selected based at least in part on user login information included in the download request.

58. The service server facility of claim 54, wherein:
each download request includes identification information applicable to identify one of a plurality of accessory cards; and
each selected service image is selected based at least in part on the identified accessory card.

59. The service server facility of claim 54, wherein:
each download request includes identification information applicable to identify the corresponding wireless device; and
each selected service image is selected based at least in part on the identified corresponding wireless device.

60. The service server facility of claim 54, wherein:
each download request includes:
login information applicable to identify one of a plurality of users,
accessory card identification information applicable to identify one of a plurality of accessory cards, and
wireless device identification information applicable to identify the corresponding wireless device; and
the selected service image is selected based at least in part on at least one criteria selected from a set of criteria including:
the identified user,
the identified accessory card, and
the identified wireless device.

61. The service server facility of claim 54, wherein:
each download request includes an indication of caching extent; and
the software further supports transmission of a subset of each selected service image via the communication mechanism to the corresponding wireless device, the subset selected based at least in part on the indication of caching extent.

62. The service server facility of claim 61, wherein the selected service image is customized based at least in part on user login information included in the download request.

63. The service server facility of claim 61, wherein:
each download request includes identification information applicable to identify one of a plurality of accessory cards; and
each selected service image is customized based at least in part on the identified accessory card.

64. The service server facility of claim 61, wherein:
each download request includes identification information applicable to identify the corresponding wireless device; and
each selected service image is customized based at least in part on the identified corresponding wireless device.

65. The service server facility of claim 61, wherein:
each download request includes:
login information applicable to identify one of a plurality of users,
accessory card identification information applicable to identify one of a plurality of accessory cards, and
wireless device identification information applicable to identify the corresponding wireless device; and
the selected service image is customized based at least in part on at least one criteria selected from a set of criteria including:
the identified user,
the identified accessory card, and
the identified wireless device.

66. The service server facility of claim 65, wherein the selected service image is selected based at least in part on at least one criteria selected from the set of criteria.

67. A system for selective configuration of a plurality of wireless devices, the system including:
a plurality of service server facilities, each of the facilities respectively including a plurality of stored service images; and
software to determine if at least one of the respective plurality of service images is an appropriate response to a received service download request sent from a corresponding one of the wireless devices in response to the corresponding wireless device being coupled with an accessory card.

68. The system of claim 67, wherein:
each of the facilities further respectively includes:
a general purpose computer system for executing the software,
a storage unit coupled to the general purpose computer system, the storage unit storing the plurality of stored service images, and
a communication mechanism coupled to the general purpose computer system; and
the software further supports:
selection of a corresponding service image from the plurality of service images whenever an appropriate response is found in response to the service download request, and
transmission of the selected service image via the communication mechanism to the corresponding wireless device.

69. The system of claim 67, wherein within each of the plurality of the service server facilities at least one the service images is unique.

70. The system of claim 67, wherein:
the download request includes at least one download request specification, including:
login information applicable to identify one of a plurality of users,
accessory card identification information applicable to identify one of a plurality of accessory cards, and
wireless device identification information applicable to identify the one of the wireless devices; and
the determination of whether at least one of the respective plurality of service images is an appropriate response is based at least in part at least one criteria selected from a set of criteria including:
the identified user,
the identified accessory card, and
the identified wireless device.

71. The system of claim 70, wherein the software further supports customization of a service image selected as an appropriate response, the customization based at least in part on at least one criteria selected from the set of criteria.

72. The system of claim 67, wherein:
the download request includes an indication of caching extent; and
the software further determines a subset of a service image selected as an appropriate response, the subset determined based at least in part on the indication of caching extent.
